(19) United States
(12) Patent Application Publication
(10) Pub. No.: US 2007/0177279 A1
(43) Pub. Date: Aug. 2, 2007

(54) Mini camera device for telecommunication devices

(75) Inventors: Sang-Hwa Cho, Gyeonggi-do (KR); Dae-Sung Kim, Gyeonggi-do (KR); Hwa-Sup Yoon, Gyeonggi-do (KR)

Correspondence Address: KELLEY DRYE & WARREN LLP, 3050 K STREET, NW, SUITE 400, WASHINGTON, DC, 20007, US

(73) Assignee: CT ELECTRONICS CO., LTD., Gyeonggi-do (KR)

(21) Appl. No.: 10/590,930

(22) PCT Filed: Sep. 20, 2004
(86) PCT No.: PCT/KR04/02400

§ 371 Date: Jan. 29, 2007

(30) Foreign Application Priority Data
Feb. 27, 2004 (KR) 10-2004-001-3598
Mar. 5, 2004 (KR) 10-2004-0015076
Mar. 8, 2004 (KR) 10-2004-0015541
Apr. 1, 2004 (KR) 10-2004-0022717

(51) Int. Cl. G02B 15/14

(52) U.S. Cl. 359/692

(57) ABSTRACT

The present invention provides a camera device which can be applied to communication devices such as a mobile phone. The camera device of the present invention has divided movement regions of a movable lens group. The movable lens group is actuated at a large width in any one movement regions to perform a zoom operation. The movable lens group is actuated at a small width in the other movement region to perform a focusing operation. Accordingly, the camera device of the present invention allows miniaturization, and can provide a zoom and a focusing function.

### TECHNICAL FIELD

The present invention relates to a compact camera device for communication devices. More specifically, the present invention is to provide a driving section for actuating the movable lenses of a camera by using an electromagnetic force which occurs between a magnet and a coil; to miniaturize a camera device by applying the driving section to a camera device for cellular phones; and to provide a zooming function and an autofocusing function to a camera device.

### BACKGROUND ART

Modem communication devices such as mobile phones, personal digital assistances (PDAs), mobile computers and the like have a camera device for video communication. Such communication devices are small, but the camera devices installed to the communication devices are not being effectively miniaturized. It is because there are much difficulties in designing miniaturization of a camera device. Conventional compact camera devices fix the lenses to have a simple configuration.

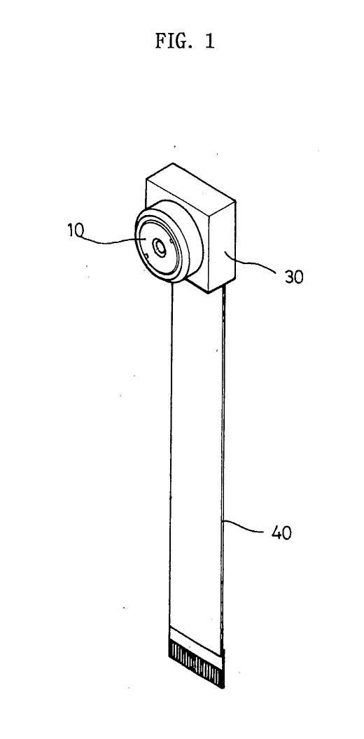

FIG. 1 shows a conventional small camera device for communications.

The conventional camera device for communications includes a lens assembly 10 and an image sensor 30.

The lens assembly 10 is fixedly installed at a predetermined interval in an upward direction of the image sensor 30. Accordingly, the camera device for communications can take photographs only in a fixed magnification and a fixed focus mode.

The image sensor 30 converts an image of an object passing through the lens assembly 10 into electric signals. Then, the image sensor 30 transmits the electric signals to a control unit of the camera device for communications by using a flexible PCB 40. The camera device for communications takes photographs by using the lens assembly 10 having a certain magnification which has been already set. Accordingly, the camera device for communications cannot magnify an object at a remote distance to take photographs.

However, a user of the camera device for communications wishes to magnify a variety of objects to take photographs. A method using a software is presented to meet the user's needs. The method has a problem in that the image quality deteriorates since it enlarges the already-taken pictures. Accordingly, the camera device for communications requires a mechanism for adjusting the magnification for a higher image quality. Also, such mechanism should miniaturize a camera device so as to be applied to communication devices.

### Disclosure

The inventors applied a method of driving the movable lenses by an electromagnetic force, which occurs between a magnet and a coil, to a camera phone.

Accordingly, an object of the present invention is to miniaturize the camera device of communication devices.

Another object of the present invention is to provide a camera for communication devices with a zooming function and an autofocusing function.

The compact camera device for communication devices according to the present invention comprises: a base; a lens assembly for converting the image of the object to a certain magnification; an image sensor fixed at the base for picking up the image of an object projected from the lens assembly; a driving section for controlling the distance between the lens assembly and the object responsive to electric signals in an optical axis direction; and a control unit for outputting the electric signals to vary the magnification of the object image.

The lens assembly of the present invention is provided with a fixed lens group, which is fixed at the base apart from the image sensor and of which the optical axis is aligned with the image sensor; and a movable lens group which is installed so as to finely move in the optical axis direction between the image sensor and the fixed lens group. The driving section of the present invention is provided with a magnet, which is fixed at the base or at any one side of the movable lens group and of which the polarity is divided in the optical axis direction; and a coil, which is fixed at the base or at the other side of the movable lens group and which is wound so as to generate a magnetic field toward the magnet.

In addition, the lens assembly of the present invention provides a fixed lens group which is fixedly installed to the base in the optical axis direction apart from the image sensor; and a movable lens group which is installed so as to finely move with the fixed lens group in the optical axis direction. The driving section of the present invention provides a first driving section for controlling the movable lens group within from a common photographing position to a 1-time zoom magnification photographing position; and a second driving section for controlling the movable lens group within from the 1-time zoom magnification photographing position to a 2-times zoom magnification photographing position. The control unit of the present invention controls the first driving section and the second driving section to vary the image magnifications.

In addition, the first driving section of the present invention provides a first coil which is wound at any one side of the base or the movable lens group so that an electric current from the control unit can be applied; and a first magnet which is fixed at the other side of the base or the movable lens group to provide a magnetic flux to the first coil. The control unit of the present invention applies a strong electric current to the first coil to thereby move the movable lens group at a large width, and the movable lens group zooms the image which is picked up by the image sensor.

In addition, the driving section of the present invention comprises a lens holder for fixing the lens assembly to align the image sensor with the optical axis; a coil which is wound around the lens holder; a plate spring fixed at the base for restoring the coil to its initial position; and a magnet fixed at the base for providing a magnetic flux to the coil. Also, the control unit of the present invention applies electric control signals to the coil through the plate spring.

Additionally, the driving section of the present invention comprises a lens barrel for aligning each lens of the lens assembly in the optical axis direction; a suspension member for raising the lens barrel from the base so as to be spaced apart from the image sensor at a predetermined interval; and an adjustment section for adjusting the gap between the lens assembly and the image sensor. The suspension member is supported at both ends of the base by at least two wires fixed at the sides of the lens barrel.

In addition, the driving section of the present invention provides a lens holder for fixing the lens assembly which is aligned with the image sensor in the optical axis direction; a coil for generating a magnetic field in the optical axis direction, which is wound at any one side of the base or the lens holder; a magnet for driving the lens holder in the optical axis direction, which is fixed at the other side of the base or the lens holder; and an initial position adjustment means installed at the base for adjusting the initial position of the lens holder. The control unit applies the electric control signals to the coil to adjust the focusing of the lens assembly.

In addition, the initial position adjustment means of the present invention provides a lever having a slope for raising and lowering the lens holder in the optical axis direction, which is rotatably supported by the base; and an elastic member for pressing the lens holder to the lever.

In addition, the lens assembly of the present invention includes a plurality of lenses for varying the image of the object to desired magnifications. The plurality of lenses finely move in the optical axis direction as the image sensor is aligned with the optical axis. The driving section of the present invention includes a coil which is wound at any one side of the base or the lens assembly; a magnet which is fixed at the other side of the base or the lens assembly; and a yoke for actuating the lens assembly in the optical axis direction by the magnetic flux of the magnet and the magnetic field of the coil when an electric current is applied to the coil.

The present invention will be explained below in more detail with the aid of exemplary embodiments with reference to the drawings. The embodiments of the present invention are presented for purposes of illustration and description. It will be apparent to those skilled in the art that the present invention is not limited to the specifically disclosed embodiments and variations, and modifications may be made without departing from the scope of the present invention.

### PREFERRED EMBODIMENTS OF THE PRESENT INVENTION

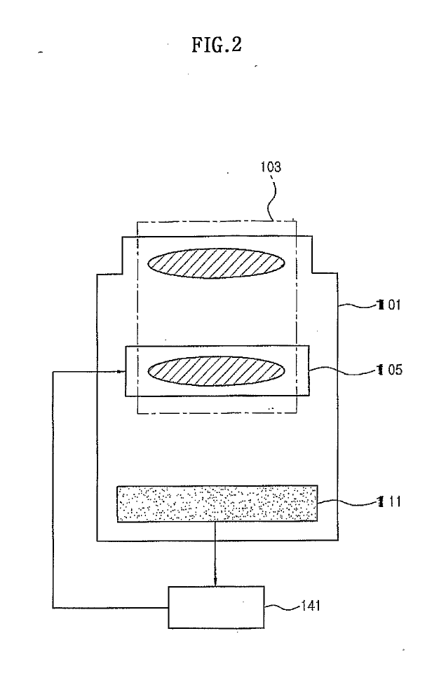

FIG. 2 illustrates the configuration of the compact camera device for communication devices according to the present invention.

The compact camera device for communication devices according to the present invention comprises a base 101; a lens assembly 103 for converting the image of an object to a certain magnification; an image sensor 111 for taking photographs of the image of the object projected from the lens assembly 103, the image sensor being fixed at the base 101; a driving section 105 for finely moving the lens assembly 103 in the optical axis direction; and a control unit 141, which actuates the image sensor 111, for outputting electric signals to the driving section 105 to vary the image magnification of the image of the object.

The control unit 141 receives image signals detected from the image sensor 111. The control unit 141 performs a zooming control and a focusing control for the driving section 105 in response to the image signals.

### Embodiment 1

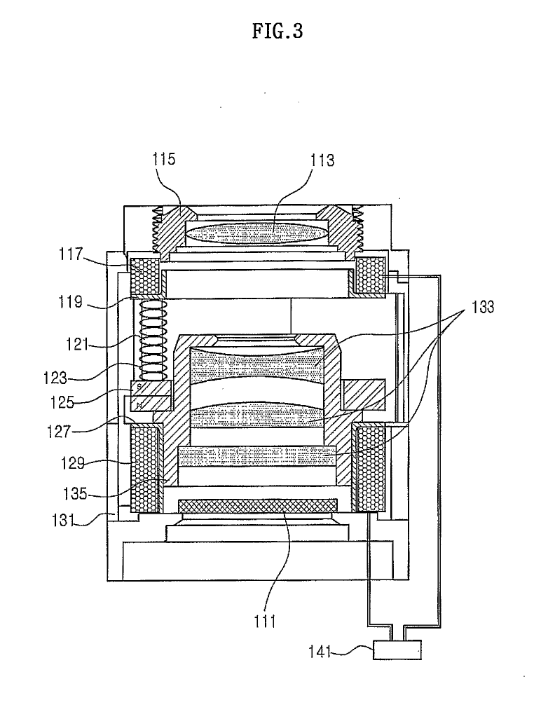

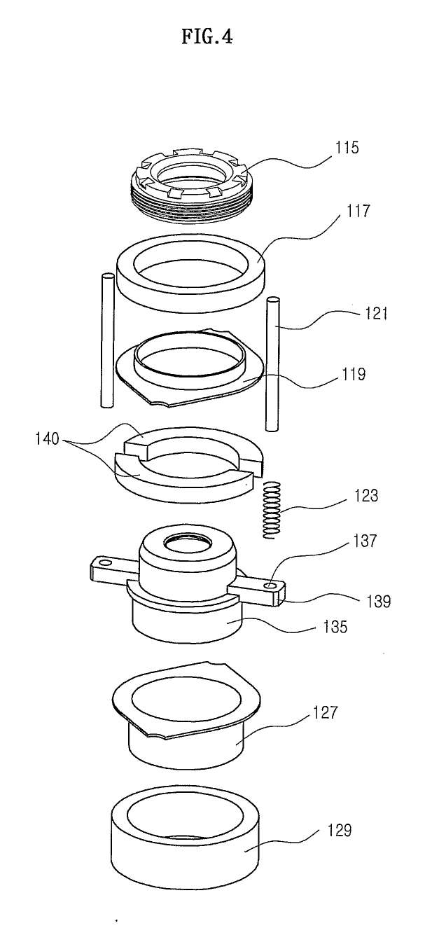

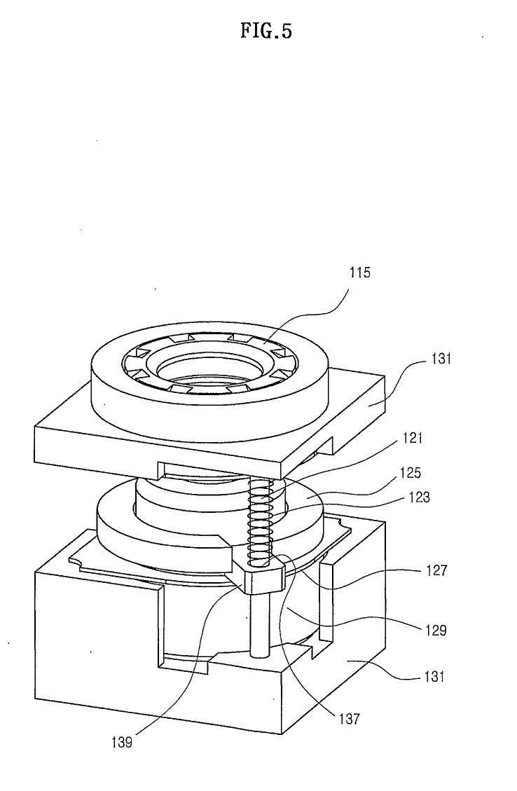

FIG. 3 is a sectional view of a camera device according to the first embodiment of the present invention. FIG. 4 is an exploded perspective view of FIG. 3. FIG. 5 is a perspective view of FIG. 3 assembled together.

The camera device according to the present invention comprises a base 101; an image sensor 111 fixed at the base 101; a lens assembly 103 consisting of a fixed lens group 113, which is installed apart from the image sensor 111 in an optical axis direction, and a movable lens group 133 for finely moving in the optical axis direction, which is installed between the image sensor 111 and the fixed lens group 113; a driving section for actuating the movable lens group 133 in the optical axis direction; and a control unit for applying power to the driving section to perform a zoom mode or a focusing mode in response to the image signals detected at the image sensor.

The driving section of the present invention includes a magnet 125 which is fixed at the movable lens group 133 and which has two polarities in the optical axis direction, and a coil for generating a magnetic field toward the magnet 125. The movable lens group 133 is fixed at the first lens barrel 135, and the fixed lens group 125 is fixed at the second lens barrel 115.

The magnet 125 is fixed at the movable lens group 133. The first lens barrel 135 provides a path along which the magnet 125 can move. The first coil 129 is wound around the outer periphery of the first lens barrel 135, and the second coil 117 is wound around the second lens barrel 115. Accordingly, the first coil 129 and the second coil 117 are spaced apart from each other at both ends of the magnet 125.

At the initial driving of the movable lens group 133, an electromagnetic force occurring between the first coil 129 and the magnet 125 moves the movable lens group 133. Then, the electromagnetic force occurring between the second coil 117 and the magnet 125 moves the movable lens group 133. In general, an actuator using a magnet and a coil can adjust only the focusing since it has a small driving width, whereas the present embodiment actuates the movable lens group 133 at a large width. This is achieved by disposing two coils at both ends of the magnet.

The first coil 129 and the second coil 117 include a first yoke. 127 and a second yoke 119, respectively. The first yoke 127 and the second yoke 119 concentrate the magnetic field occurring from the first coil 129 and the second coil 117 to the magnet 125, and circulate the magnetic field. The magnetic field 125 is provided inside the first coil 129 and the second coil 117 which are located between the first yoke 127 and the second yoke 119.

The control unit 141 applies a strong electric current to the coils to move the movable lens group 133 in a large width. The movement of the movable lens group 133 performs the zooming with respect to an image picked up by the image sensor 111. Thereafter, the control unit 141 of the present invention applies a weak electric current to the coils to move the movable lens group 133 at a small width, whereby the focus of the image picked up by the image sensor becomes clear.

The base 101 includes a pair of guide shafts 121 in the optical axis direction. The first lens barrel 135 includes a pair of wings 137. The pair of wings 137 have guide holes 139 for passing through the guide shafts 121.

The base 101 includes a compression spring 123 as restoring means. The compression spring 123 is inserted into the guide shafts 121, and the guide shafts 121 have a restoring force for moving the movable lens group 133 to its common photographing position.

When the movable lens group 133 comes close to the image sensor 111, the arrangement of each lens of the fixed lens group 113 and the movable lens group 133 is suitable for a low magnification photographing. When the movable lens group 133 comes close to the fixed lens group 113, the arrangement of each lens of the fixed lens group 113 and the movable lens group 133 is suitable for a high magnification photographing.

The magnet 125 as shown in FIG. 3 has N polarity downward, and the first coil 129 generates a magnetic field of N polarity upward. The second coil 117 generates a magnetic field of N polarity downward. The control unit 141 for controlling the image sensor 111 and the coils is installed in the main body of communication devices. The control unit 141 is connected to the image sensor 111 and the coils through a wire or a flexible PCB. A keypad of the communication devices includes an on/off button for actuating the image sensor 111. The keypad of the communication devices includes a low-magnification photo button and a high-magnification photo button for performing an optical zooming and a focusing.

After the zooming operation is performed using the keypad, when the control unit 141 recognizes a focusing error for the photographed image, the control unit 141 performs a mode for compensating for the focusing error This is achieved in such a manner that the control unit 141 applies a weak electric current to the first coil 129 and the second coil 117.

The camera device according to the present embodiment moves the movable lens group 133 by using the electromagnetic force occurring between the magnet 125 and the coils. The movable lens group 133 adjusts the magnification for zooming or focusing, which does not include a complex gear device used in the conventional camera device. Accordingly, the camera device of the present invention allows miniaturization, and can be applied to compact communication devices.

When the camera device according to the present embodiment is applied to a cellular phone, the camera device can be installed at any part of a main body or of a folder. Also, the camera device can be installed in a hinge barrel for rotating the folder from the main body.

The operation of the camera device according to the present embodiment will be described below.

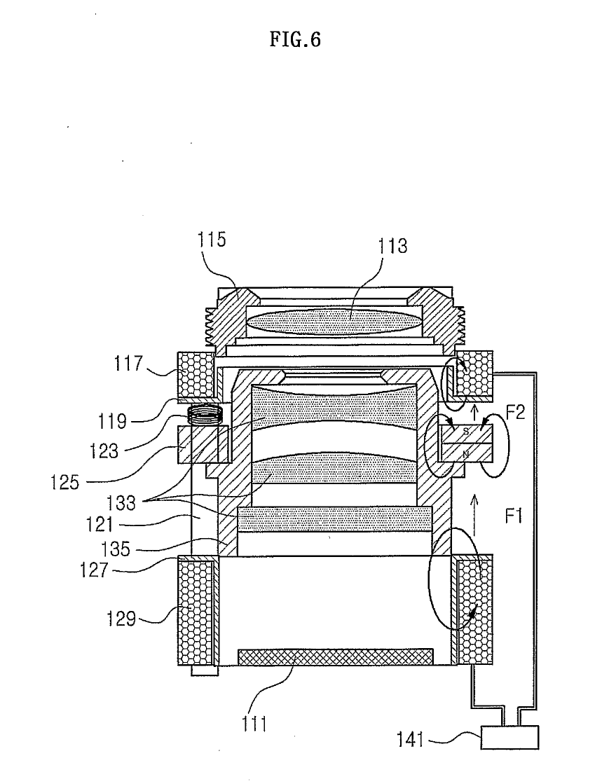

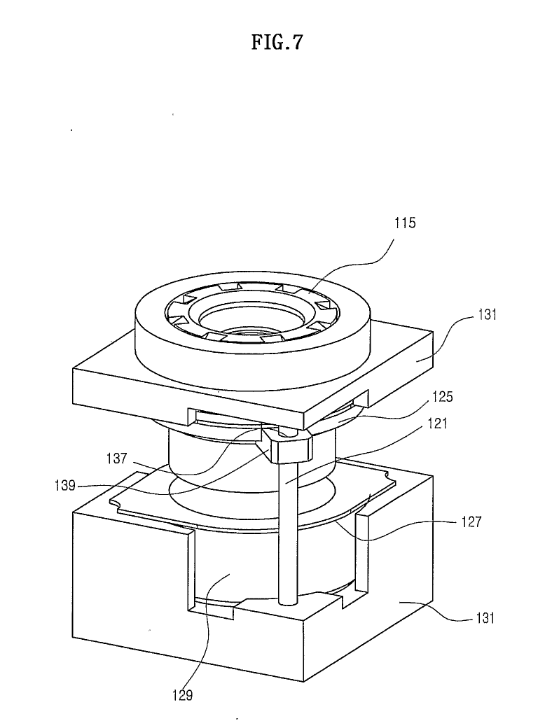

FIG. 6 is a sectional view of the in-use state of FIG. 5. FIG. 7 is a perspective view of the in-use state of FIG. 5.

The camera device remains in a state in which a low magnification photographing is possible as shown in FIG. 3. That is, at the initial state, the control unit 141 does not apply power to the first coil 129 and the second coil 117. Accordingly, the compression spring 123 pushes the wings of the first lens barrel 135 fixed at the movable lens group 133 to come close to the image sensor 111. The camera device remains in a low magnification photographing state.

At this time, when a user operates a photo button by using the keypad installed at the communication device, the image of the object positioned in front of the fixed lens group 113 is provided to the image sensor 111 through the fixed lens group 113 and the movable lens group 133. The image sensor 111 converts the image of the object into electric signals. The electric signals are transmitted to the control unit 141 via the flexible PCB. This is a low magnification photographing state.

When the user wishes to magnify a remote object to take pictures, the user operates a button for a high magnification photographing by using the keypad at the main body of the cellular phone. The control unit 141 applies power to the first coil 129 and the second coil 117.

The first coil is supplied with power to generate a magnetic field of N polarity in the upward direction of FIG. 6. The magnetic field collides with the magnetic field of N polarity, which occurs at the magnet 125, to thereby generate a repulsive force F1, so that the magnet 125 moves upward.

When the magnet 125 is transferred upward at a predetermined distance, the repulsive force F1 occurring between the first coil 129 and the magnet 125 decreases, and an attraction force occurring between the second coil 117 and the magnet 125 is exerted. The second coil 117 generates a magnetic field of N polarity downward, and the magnet 125 generates a magnetic field of S polarity upward. An attraction force occurs between the second coil 117 and the magnet 125. Accordingly, the magnet 125 can move to the topmost part.

The first yoke 127 and the second yoke 119 concentrate the magnetic field occurring from the first coil 129 and the second coil 117 toward the magnet 125. The first yoke 127 and the second yoke 119 circulate the magnetic field to double the electromagnetic force.

The magnet 125 raises the first lens barrel 135 and the movable lens group 133 by the magnetic field. Accordingly, the fixed lens group 113 and the movable lens group 133 become spaced apart from the image sensor 111 to be converted to a high magnification state. The adjustment of magnification width is made by the size of voltage applied to the first coil 129 and the second coil 117. The size of voltage adjusts the width of which the movable lens group 133 moves, so that the magnification adjustment is possible.

After the zooming adjustment is performed, the control unit 141 detects a focusing error with respect to a photographed image. If there is a focusing error, the control unit 141 applies a weak electric current to the first coil 129 and the second coil 117. This is a mode for compensating for the focusing error.

The mode for compensating for the focusing error is achieved in such a manner that the control unit 141 continuously applies power to the first coil 129 and the second coil 117 so that the position of the movable lens group 133 is fixed. The camera device of the present invention performs optical zooming and focusing.

When the user takes pictures in a low magnification mode after completing the high magnification mode, the user operates a low magnification photo button by using the keypad of the communication device. The control unit 141 blocks power supplied to the first coil 129 and the second coil 117. Accordingly, the electromagnetic force occurring between the first coil 129 and the second coil 117 and the magnet 125 disappears. The first lens barrel 135 moves the movable lens group 133 toward the image sensor 111 by the pressing force of the compression spring 123. As shown in FIG. 3, the arrangement of the fixed lens group 113 and the movable lens group 133 is converted to a low magnification mode.

The low magnification photographing mode is maintained in such a manner that the compression spring 123 pressurizes the first lens barrel 135. It is not necessary to apply an electric current to the first coil 129 and the second coil 117.

### Embodiment 2

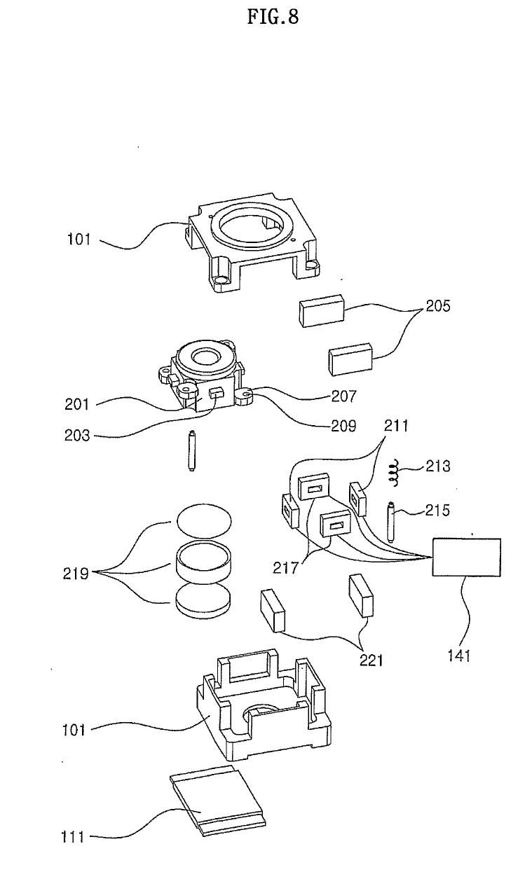

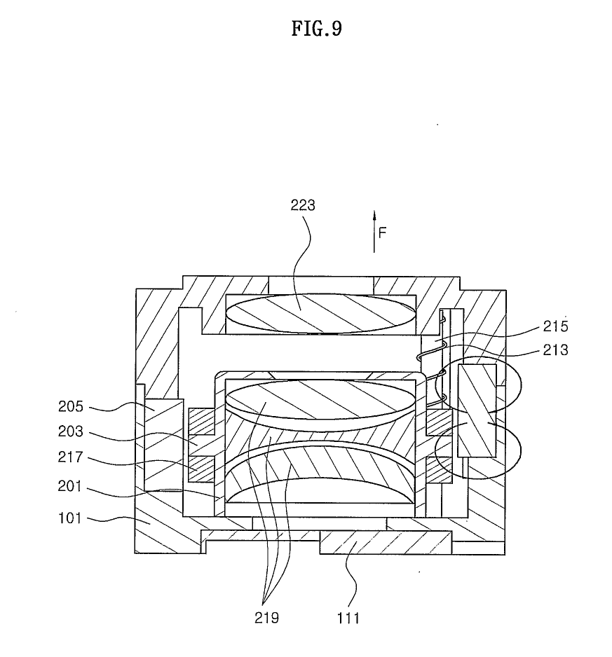

FIG. 8 is an exploded perspective view of the camera device according to the second embodiment of the present invention. FIG. 9 is a sectional view of FIG. 8 assembled together.

The camera device according to the second embodiment of the present invention comprises a base 101; an image sensor 111 fixed at the base 101; a lens assembly 103 consisting of a fixed lens group 223, which is fixed at the base 101 so as to be aligned with the optical axis at a predetermined interval from the image sensor 111, and a movable lens group 219, which is installed in such a manner that the movable lens group 219 is aligned with the optical axis so as to finely move in the optical axis direction; a driving section 105 consisting of a first driving section for actuating the movable lens group 219 within from a 1-time zoom magnification photographing position to the initial photographing position, and a second driving section for driving the movable lens group 219 within from the 1-time zoom magnification photographing position to a 2-times zoom magnification photographing position; and a control unit for applying power to the driving section 105 to perform a zooming mode or a focusing mode responsive to the image signals detected at the image sensor 111.

The first driving section is wound at the side of a lens barrel 201 to which the movable lens group is fixed, and is fixed at the first coils 217 and the base 101. The first magnet 205 has any of one polarity and provides a magnetic flux in the normal direction of the winding surface of the first coils 217. The second driving section is wound at the side of the lens barrel 201 and fixed at the second coils 211 and the base 101. The second magnet 221 has the other polarity and provides a magnetic flux in the normal direction of the winding surfaces of the second coils 211.

The outer periphery of the lens barrel 201 is provided with prominences at the position where the first coils 217 and the second coils 211 are fixed. The first coils 217 and the second coil 211 are wound in a rectangular shape. The centers of the first coils 217 and the second coils 211 are inserted into each prominence to be adhered by an adhesive.

The control unit 141 applies a strong electric current to the first coils 217 and the second coils 211 to move the movable lens group 219 at a large width. Accordingly, the camera device performs an optical zoom with respect to the image picked up by the image sensor 111. The control unit 141 also applies a weak electric current to the first coils 217 and the second coils 211 to move the movable lens at a small width. Accordingly, the camera device makes the focus of the image picked up by the image sensor 111 to be clear.

At the beginning of the performance of a zoom mode, the camera device according to the present embodiment applies power to the first coils 217. The control unit 141 moves the movable lens group 219 with an electromagnetic force occurring between the first magnet 205 and the first coils 217. The control unit 141 adjusts the zoom within from the common photographing position to the 1-time zoom magnification position. Also, the control unit 141 applies power to the second coils 211. The control unit 141 moves the movable lens group 219 by using an electromagnetic force occurring between the second magnet 221 and the second coils 211. The control unit 141 adjusts the zoom within from the 1-time zoom magnification position to the 2-times zoom magnification position.

Accordingly, the driving section 105 according to the present invention is provided with two driving sections. Due to the two driving sections, it is possible to drive the movable lens group 219 at a large width to adjust the zoom, and to drive the movable lens group 219 at a small width to adjust the focusing.

The compact camera device according to the second embodiment guides the movable lens group 219 to move in the optical axis direction. To do this, guide shafts 215 are fixed at the base 101 in the optical axis direction. The lens barrel 201 includes wings 207 for passing through the guide shafts 125, and the wings 207 have guide holes 137.

The base 101 has a restoring means for restoring the movable lens group 219 to its initial photographing position. The restoring means is a compression spring 213, which is inserted into the guide shaft 215.

The arrangement of each lens of the fixed lens group 223 and the movable lens group 219 will be explained below.

When the movable lens group 219 comes close to the image sensor 111, the arrangement of the fixed lens group 223 and the movable lens group 219 is set so as to be suitable for a low magnification photographing. Also, when the movable lens group 219 comes close to the fixed lens group 223, the arrangement of the fixed lens group 223 and the movable lens group 219 is set so as to be suitable for a high magnification photographing.

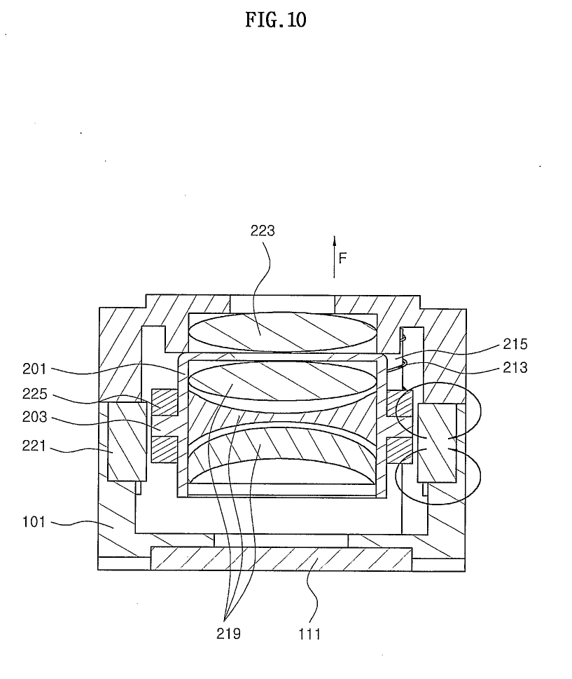

The first magnet 205 and the second magnet 221 are illustrated in FIGS. 9 and 10. The first magnet 205 magnetizes N polarity in the direction where the first coils 217 and the second coils 211 are installed. The first magnet 205 and the second magnet 221 provide a magnetic flux to the first coils 217 and the second coils 211.

The magnetic flux provided from the first magnet 205 and the second magnet 221 is provided in the normal direction of the winding surfaces of the first coils 217 and the second coils 211. The winding surfaces are the horizontal sections of the coils wound in a rectangular shape. There are two horizontal sections in each coil, and when the magnetic flux passes all of the horizontal sections, the electromagnetic force is compensated so that it cannot actuate the lens barrel 201.

The control unit 141 controls the image sensor 111, the first coils 217, and the second coils 211. Since the control unit 141 is embedded in the main body of communication devices, it is connected to the image sensor 111 and the first coils 217 and the second coils 211 by using wires or a flexible PCB. The keypad of the communication devices comprises a plurality of buttons. The plurality of buttons include a button of performing an on/off actuation of the image sensor 111 and a low-magnification and a high-magnification photo buttons for controlling the optical zooming and the focusing of the movable lens group 219.

After the zoom adjustment is performed, the control unit 141 determines whether a focusing error of a photographed image occurred. As a result of the determination, if the control unit 141 detects a focusing error, the control unit 141 applies a weak electric current to the first coil 217 and the second coil 211 to perform a mode for compensating for the focusing error.

The user adjusts the time of pressing the high magnification photo button to perform a volumetric adjustment of the zoom. The control unit 141 adjusts the voltage applied to the first coils 217 and the second coils 211 to perform the volumetric adjustment of the zoom.

The camera device according to the second embodiment does not perform the magnification adjustment by using a complex gear device. The camera device moves the movable lens group 219 by using the electromagnetic force occurring between the magnets and the coils to adjust the magnification. Accordingly, the camera device according to the present invention allows miniaturization and can be applied to compact communication devices.

The operation of the camera device according to the second embodiment will be explained hereinbelow.

FIG. 9 is a sectional view showing the state before operation of the camera device. FIG. 10 is a sectional view showing the state after operation of the camera device.

The camera device is maintained in a low magnification photographing mode as shown in FIG. 9. That is, the magnetic flux of the first magnet 205 and the second magnet 221 passes through the first coils 217 and the second coils 211. However, power is not applied to the first coils 217 and the second coils 211. Accordingly, the movable lens group 219 does not move. The compression spring 213 pressurizes the wings 207 of the lens barrel 201 to which the movable lens group 219 is fixed. The movable lens group 219 comes close to the image sensor 111 to be maintained in a low magnification photographing mode.

The user operates the photo button by using the keypad installed at the communication device. The image of the object is picked up through the fixed lens group 223 and the movable lens group 219. The image sensor 111 converts the image into electric signals. The electric signals are transmitted to the control unit 141 via the flexible PCB. Accordingly, the control unit 141 performs the low magnification photographing.

When the user wishes to magnify the remote object to take pictures, the user operates the high magnification photo button by using the keypad. The control unit 141 applies power to the first coils 217.

When the control unit 141 applies power to the first coils 217, an electromagnetic force F occurs in the rising direction of the first coils 217 due to the magnetic flux occurring from the first magnet 205. Accordingly, the first coils 217 and the lens barrel 201 raise the movable lens group 219 to the 1 -time zoom magnification photographing position.

When the control unit 141 moves the movable lens group 219 to the 2-times zoom magnification photographing position, the control unit 141 blocks the power supply to the first coil 217 and applies power to the second coil 211. When the control unit 141 applies power to the second coil 211, the electromagnetic force F raises the second coil 211. It is because the second coil 211 is affected by the magnetic flux occurring from the second magnet 221.

Accordingly, the second coil 211 rises together with the lens barrel 201. The lens barrel 201 moves the movable lens group 219 to the 2-times zoom magnification photographing position.

This operation is as shown in FIG. 10. The electromagnetic force F moves the movable lens group 219 from a common photographing position to the 2-times zoom magnification photographing position. The user operates the photo button by using the keypad installed at the communication device. An image is picked up by the image sensor 111 with the fixed lens group 223 and the movable lens group 219 in a high magnification mode. The image sensor 111 converts the image into the electric signals to be transmitted to the control unit 141 via the flexible PCB. Then, the zoom adjustment is performed.

Meanwhile, the control unit 141 determines whether or not a focusing error with respect to the photographed image exists. If the control unit 141 recognizes the existence of the focusing error, the control unit 141 applies a weak electric current to the first coils 217 and the second coils 211. Accordingly, the control unit 141 performs a mode for compensating for the focusing error.

The compression spring 213 pressurizes the first lens barrel 135 downward. At the same time, the control unit 141 continuously applies power to the first coils 217 or the second coils 211. Accordingly, the movable lens group 219 maintains a fixed position. The control unit 141 performs the optical zooming and the focusing of the camera device according to the present embodiment.

When the user completes a high magnification photographing and then performs a low magnification photographing again, the user operates the low magnification photo button. The control unit 141 recognizes the operation signal of the photo button. The control unit 141 blocks all power supplied to the first coils 217 and the second coils 211. The first coils 217 and the second coils 211 extinguish all electromagnetic force. Accordingly, the lens barrel 201 moves the movable lens group 219 toward the image sensor 111 by the pressurizing force of the compression spring 213. Thus, the arrangement of the fixed lens group 223 and the movable lens group 219 becomes suitable for a low magnification photographing. And the compression spring 213 pressurizes the lens barrel 201 by an elastic force to be maintained in a low magnification photographing mode.

### Embodiment 3

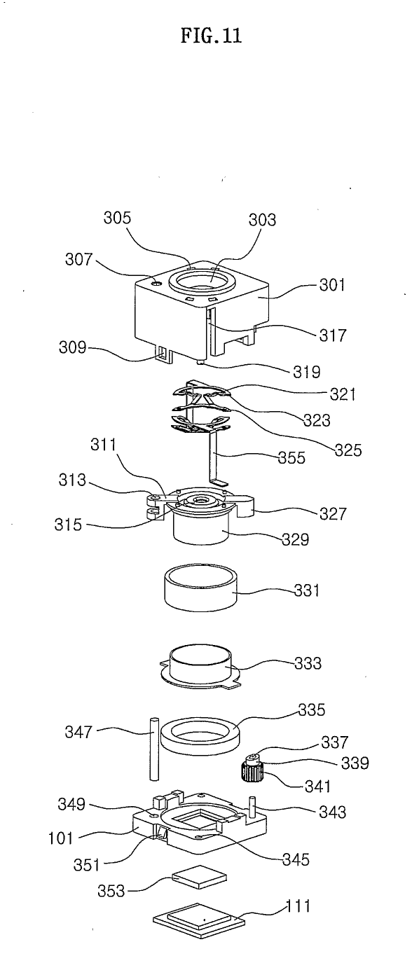

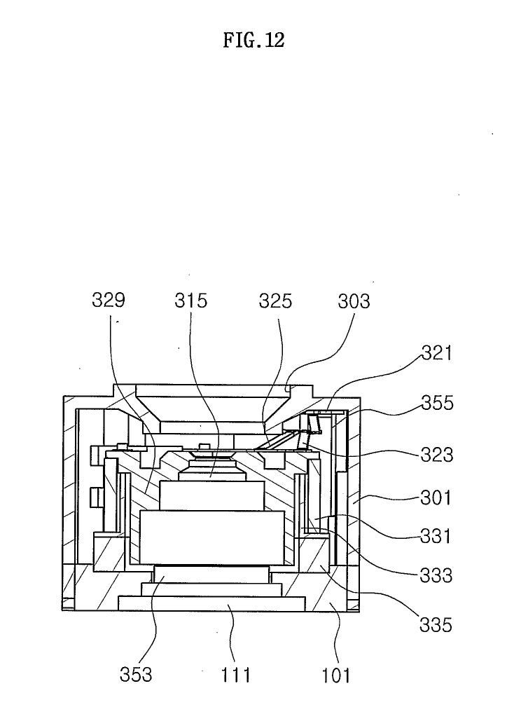

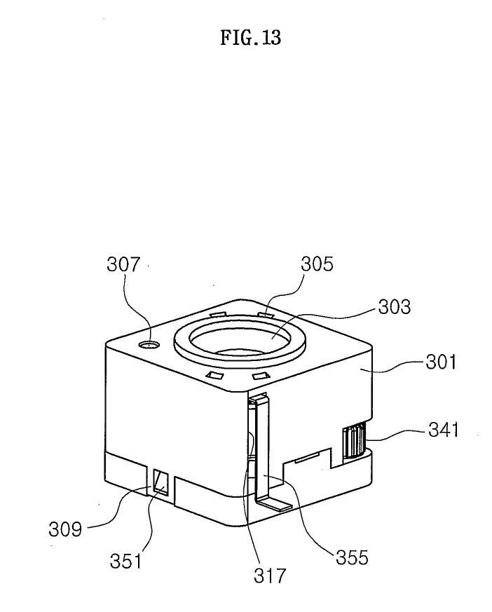

FIG. 11 is an exploded perspective view of a camera device according to the third embodiment of the present invention. FIG. 12 is a sectional view of FIG. 11 assembled together. FIG. 13 is a perspective view of FIG. 11 assembled together.

The camera device according to the present embodiment comprises a base 101; an image sensor 111 fixed to the base 101 for photographing the image of an object; a lens assembly 103 including a plurality of lenses, which converts the image of the object into a certain magnification to be transmitted to the image sensor 111; a lens holder 329 for fixing the plurality of lenses and the image sensor 111 so as to align the image sensor 111 with the optical axis; a coil 331 wound around the lens holder 329; a plate spring 355 which generates a predetermined elastic force for restoring the coil 331 to its initial position, one end thereof being fixed at the base 101 and the other end being connected to the coil 331; a driving section 105 consisting of a magnet 335 for generating magnetism with the coil 331 to drive the coil 331 in the optical axis direction, the driving section being fixed at the base 101; and a control unit 141 for applying power to the driving section 105 to perform an autofocusing mode responsive to the image signals detected at the image sensor 111.

The base 101 includes initial position setting means for setting the initial position of the lens holder 329. The initial position setting means is comprised of a second guide shaft 343 which is fixed at the base 101 in the optical axis direction; a lever 341 having a second axis hole 337 rotatably joined to the second guide shaft 343, the upper surface thereof formed with a slope 339; and a lifting prominence 327 formed at the lens holder 329, which contacts the slope 339 to be raised and lowered by the rotation of the lever 341.

Also, the camera device according to the present embodiment has guide means for guiding the lens holder 329 in the optical axis direction. The guide means has a first guide shaft 347 which is fixed at the base 101 in the optical axis direction; and a shaft holder 311 formed at the lens holder 329 having guide holes 307 which is joined by the guide shafts so as to be slidable in the optical axis direction. The base 101 has a joint hole 349 for joining the first guide shaft 347.

The magnet 335 includes a magnetic circulation yoke 333 for inducing the magnetic flux of the magnet 335 to the coil 331.

A cover 301, which protects the lens holder 329, the magnet 335, the coil 331, and the magnet 35 from the external shock and which has a light passing hole 303 for passing the light to the lens assembly 315, is joined to the base 101. The bottom surface of the cover 301 is provided with a plurality of prominences 319 and locking portions 309. The upper surface of the base 101 has grooves 345 joining the prominences 319 and locked portions 351 where the locking portions 309 are locked. The cover 301 forms a plurality of throughholes 305 for coupling it with the plate spring 355 and a cutaway portion 242 for releasing the plate spring 355 to the outside. The cover 301 forms a guide hole 307 for guiding the upper portion of the first guide shaft 347.

The plate spring 355 has a protrusion 321 for joining a portion thereof through the throughholes of the cover 301. Also, the plate spring 355 includes a connecting portion 323 for connecting it to the coil 331, and forms an elastic portion 325 for pressurizing the lens holder 329 with an elastic force to be restored to its initial position.

When the plate spring 355 is joined to the cover 301, a portion of the protrusion 321 is inserted into the throughholes 305 of the cover. Then, an adhesive is injected into the throughholes 305 from the outside of the cover 301 to fix the plate spring 355 to the cover 301.

The image sensor 111 comprises a filter 353 for blocking the infrared rays included in the light source of the object. The control unit 141 controlling the image sensor 111 and the coil 331 is embedded in the main body of the communication device. Accordingly, the control unit 141 is connected to the image sensor 111 and the coil 331 by using wires or a flexible PCB.

The camera device according to the third embodiment includes a photo button for operating the image sensor 111. When the photo button operates, the control unit 141 applies power to the coil 331 to actuate the lens holder 329. The operation of the lens holder 329 performs the focusing so that the image of the object picked up by the image sensor 111 becomes clear.

The camera device of the present invention actuates the lens holder 329 by using the electromagnetic force occurring between the magnet 335 and the coil 331. Accordingly, it is possible to miniaturize the size of the camera device according to the present embodiment, and to apply the camera device to the compact communication devices such as mobile phones.

The operation of the camera device according to the present embodiment will be explained below.

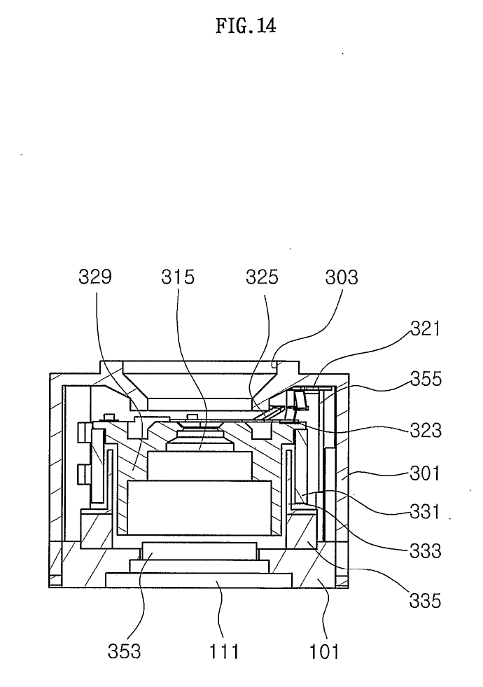

FIG. 12 is a sectional view showing the state before operation of the camera device according to the present embodiment. FIG. 14 is a sectional view showing the state after operation of the camera device according to the present embodiment.

The lever 341 rotates so that the lens holder 329 can be set at an appropriate height. As the lever 341 rotates, the slope 339 of the lever 341 raises or lowers the lifting prominence 327 fixed at the lens holder 329. Accordingly, the height of the lens holder 329 can be adjusted. When the height of the lens holder 329 is properly adjusted, the lever 341 is fixed by an adhesive.

As shown in FIG. 12, the plate spring 355 pressurizes the lens holder 329 with a predetermined elastic force, so that the lens holder 329 is fixed at the initial photographing position.

When the photo button installed at the communication device is operated, the control unit 141 applies power to the coil 331 through the plate spring 355. The coil 331 actuates the lens holder 329 to perform focusing. The focusing makes the image of the object to be picked up by the image sensor 111.

When the control unit 141 applies power to the coil 331, the coil 331 generates an electromagnetic force driving in the optical axis direction due to the magnetic flux which is generated at the magnet 335 and moves to the yoke 333. The lens holder 329 overcomes the elastic force of the plate spring 355 to rise. Accordingly, it becomes possible for the lens holder 329 to freely oscillate.

The control unit 141 finely adjusts the direction of the electric current applied to the coil 331. The control unit 141 finely raises or lowers the lens holder 329 to make the image of the object to be picked up by the image sensor 111.

The image of the object in front of the lens group 315 passes through the lens group 315 so that the infrared rays are removed from the filter 353. The image sensor 111 converts the image of the object into the electric signals to be transmitted to the control unit 141.

The first guide shaft 347 is coupled to a first shaft hole 313 of the shaft holder 311 formed at the lens holder 329. Accordingly, the first guide shaft 347 guides the lens holder 329 so as to be accurately moved in the optical axis direction.

### Embodiment 4

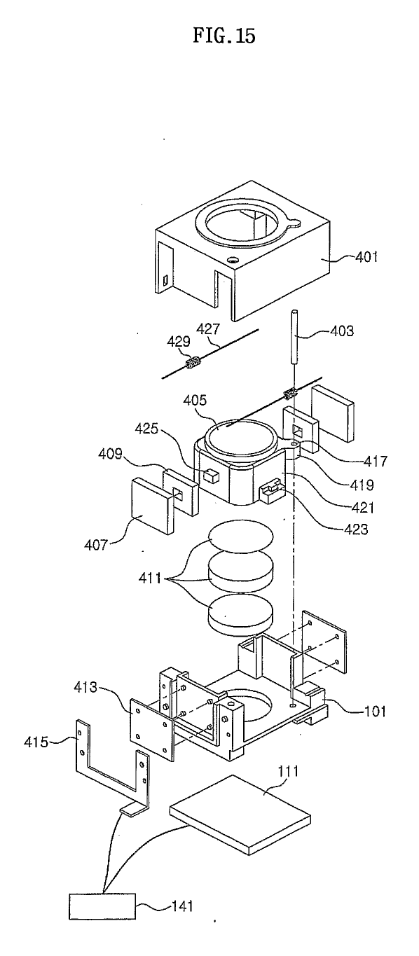

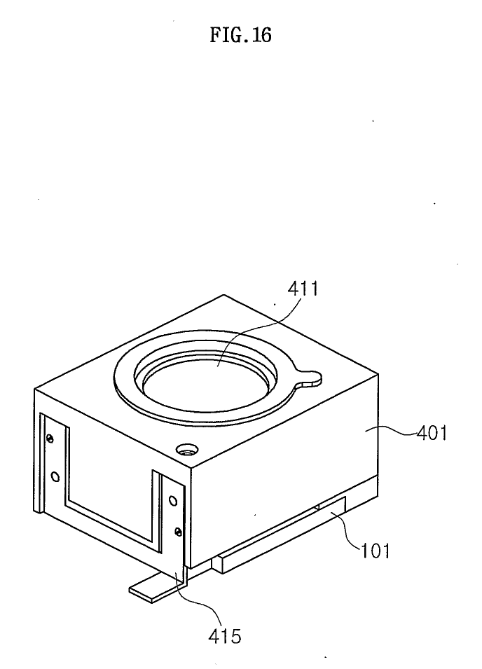

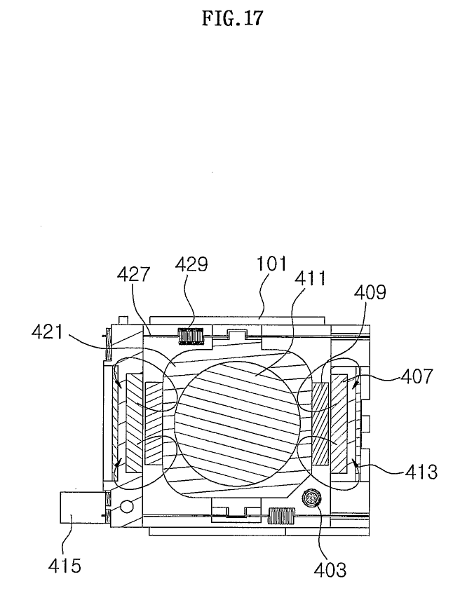

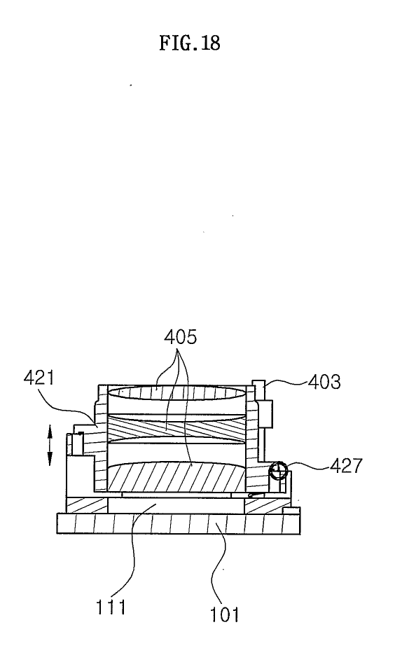

FIG. 15 is an exploded perspective view of the camera device according to the fourth embodiment of the present invention. FIG. 16 is a perspective view of FIG. 15 assembled together. FIG. 17 shows a transverse cross-section of FIG. 16. FIG. 18 shows a longitudinal section of FIG. 6.

The camera device according to the present embodiment comprises a base 101; an image sensor 111 for picking up an image of an object, the image sensor being fixed at the base 101; a lens group 103 consisting of a plurality of lenses; a lens barrel 421 for aligning the lens group 103 in the optical axis direction; a suspension member for raising the lens barrel 421 from the base 101 so that the lens barrel 421 may move away from the image sensor 111; a driving section 105 comprising a gap regulator for adjusting the gap between the lens group 103 and the image sensor 111 to make the image picked up by the image sensor 111 to be clear; and a control unit 141 for applying power to the driving section 105 in order to perform a focusing mode responsive to the image signals detected at the image sensor 111.

Both ends of the suspension member are supported at the base 101. The central portion of the suspension member includes two wires 427 which are fixed at both sides of the lens barrel 421. The lens barrel 421 has a recess 423 for inserting the wires 427 at the side thereof.

The wires 427 are provided with a spring portion 429 having a tensile elasticity at the central portion. The lens barrel 421 rises from the base 101 by the wires 427.

The gap regulator includes a pair of coils 409. The pair of coils 409 are wound at both sides of the lens barrel 421 in a rectangular shape. The electric current is applied to the coils 409 from the control unit 141. A pair of magnets 407 are fixed at the base 101. The polarity of the pair of magnets 407 is divided so that the magnetic flux may pass in the normal direction of the winding surface of each coil 409.

Both sides of the lens barrel 421 include fixing protrusions 425 for fixing the coils 409. The central portions of the coils 409 are inserted into the fixing protrusions 425 to be attached by an adhesive.

The magnets 407 are magnetized so that N polarity can face the coils 409. Accordingly, the magnetic flux from the magnets 407 is provided in the normal direction of the winding surfaces of the coils 409.

The coils 409 are wound in a rectangular shape, so there exist two planar winding surfaces. When the magnetic flux passes both of the two planar winding surfaces, the electromagnetic force is counterbalanced, and thus the lens barrel 421 cannot be actuated.

The gap regulator raises or lowers the lens barrel 421 according to the direction of the electric current applied to the coils 409 from the control unit 141 to thereby adjust a focusing. In addition, a magnetic substance 413 for circulating the magnetic flux of the magnets 407 is fixed at the base 101 which contacts the backside of the magnets 407.

A flexible PCB 415 is fixed at the base 101, and the flexible PCB 415 is connected to the control unit 141. The flexible PCB is connected to one end of the wire 427, and the other end of the wire 427 is connected to the coil 409.

The base 101 includes a guide shaft 403 fixed in the optical axis direction so that the movable lens group 411 can accurately move in the optical axis direction. The lens barrel 421 includes a wing 419 comprising a guide hole 417 for sliding the guide shaft 403.

The camera device according to the present embodiment comprises a cover 401 for protecting all parts, the cover 401 being combined with the base 101. When the camera device is installed at the communication device, the base 101 is attached to the main body, the folder, or the hinge device of the communication device. The control unit 141 applying power to the image sensor 111 and the coils 409 is embedded in the main body of the communication device.

The keypad of the communication device includes a photo button for photographing an image. When the photo button operates, the control unit 141 actuates the image sensor 111 to photograph an image of an object. At this time, the control unit 141 applies an electric current to the coils 409 in order to perform a mode of compensating for a focusing error.

The camera device according to the present embodiment actuates the lens barrel 421 by using the magnets 407 of a small volume and the coils 409. Accordingly, the camera device allows the miniaturization of the whole module, and can be applied to a compact communication device such as a mobile phone.

The operation of the camera device according to the present embodiment is described hereinbelow.

When the photo button installed on the communication device operates, the control unit 141 actuates the image sensor 111. Accordingly, the communication device photographs the image of the object picked up by the image sensor 111. The image sensor 111 converts the picked-up image into electric signals. The electric signals are transmitted to the control unit 141 through the flexible PCB 415.

The control unit 141 determines whether the picked-up image is clear. If control unit 141 determines that the image is not clear, the control unit 14 1 applies power to the coils 409 to adjust a focusing. If the power is applied to the coils 409, the lens barrel 421 is raised or lowered by the direction of the electric current and the magnetic flux occurring at the magnets 407. The control unit 141 adjusts the direction of the electric current and the voltage to finely move the lens barrel 421, and makes the image picked up by the image sensor 111 to be clear.

At this time, the spring portion 429 of the wires 427 extends/retracts, so that the lens barrel 421 can freely oscillate. Accordingly, the focusing adjustment is made with respect to the lens group 103. As a result, the image picked up by the image sensor 111 becomes clear.

### Embodiment 5

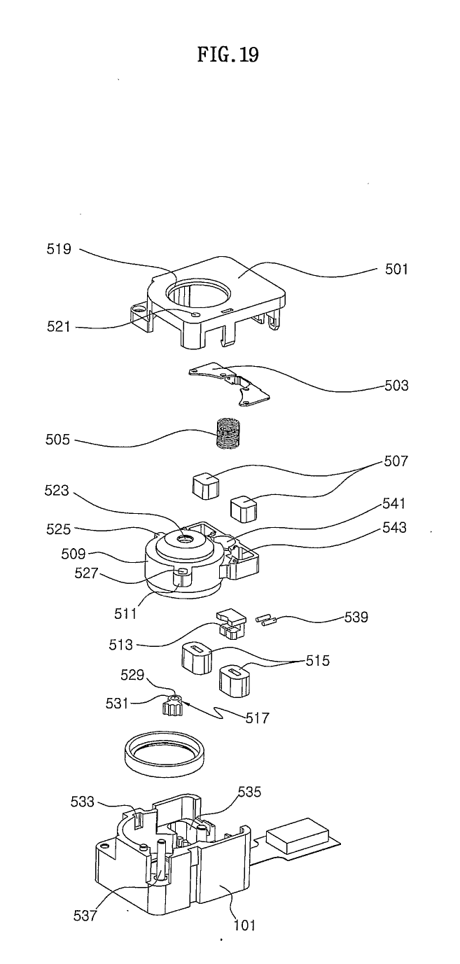

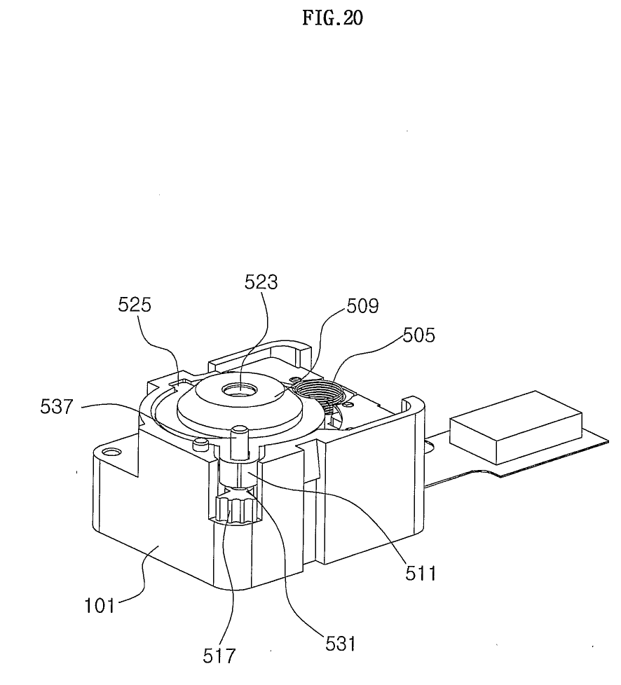

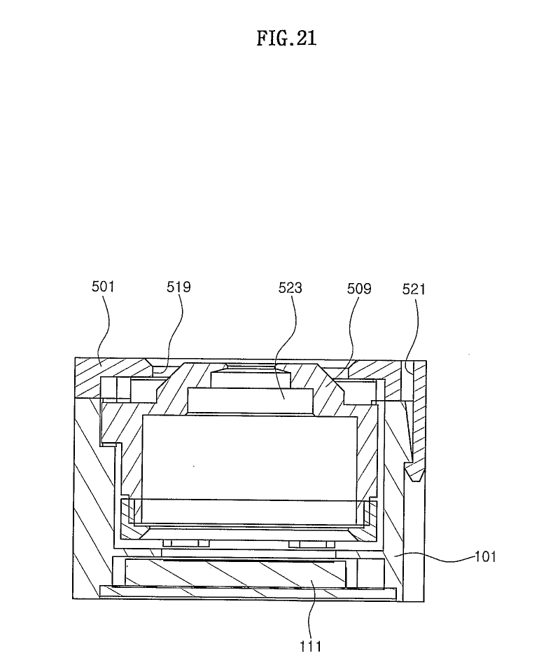

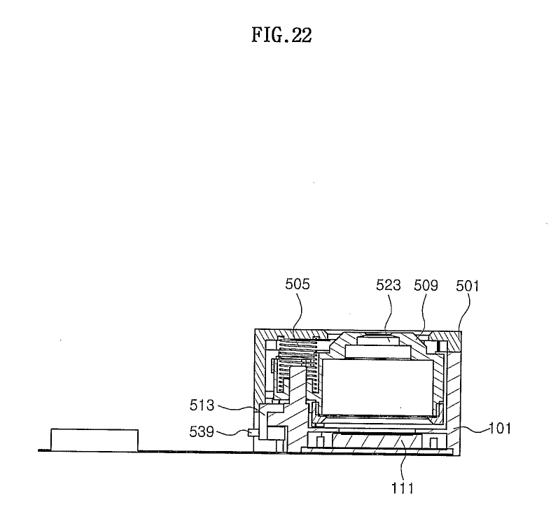

FIG. 19 is an exploded perspective view of the camera device according to the fifth embodiment of the present invention. FIG. 20 is a perspective view of FIG. 19 assembled together. FIGS. 21 and 22 are the cross-sections of FIG. 19 assembled together.

The camera device according to the fifth embodiment comprises a base 101; an image sensor 111 fixed at the base 101 for picking up an image of an object; a lens group 103 for converting the image of the object to a certain magnification, which is installed in the optical axis direction of the image sensor 111; a driving section 105 comprising a lens holder 103 for aligning the lens group 103 with the image sensor 111 in the optical axis direction, coils 515 for generating a magnetic field by an input electric current in the optical axis direction, the coils 515 being wound at the base 101 and at one side of the lens holder 509 to be fixed, magnets 507 for driving the lens holder 509 by the magnetic field occurring at the coils 515 in the optical axis direction, the magnets 507 being fixed at the other side of either the base 101 or the lens holder 509, initial position adjustment means installed at the base 101 for adjusting the initial position of the lens holder 509; and a control unit 141 for applying power to the coils to perform a zoom mode or a focusing mode responsive to image signals detected at the image sensor 111.

The initial position adjustment means includes a lever which is rotatably supported at one side of the base 101 and which radially forms a slope 531 for raising or lowering the lens holder 509 in the optical axis direction; and an elastic member for pressurizing the lens holder 509 toward the lever 517. Preferably, the elastic member is a compression spring 505.

The base 101 includes guide means for guiding the lens holder 509 in the optical axis direction. The guide means includes a first guide shaft 537 which is fixed at the base 101 in the optical direction; and a shaft holder 511 which is formed at the lens holder 509 and has a guide hole 527 so that the first guide shaft 537 may slide in the optical axis direction.

The guide means includes a guide protrusion 525 formed at the lens holder 509; and a guide groove 533 for guiding the guide protrusion 525 so as to be slidable in the optical axis direction, which is formed at the base 101 in the optical axis direction.

The lever 517 forms a shaft hole 529, which is coupled to the guide shaft 537, and the shaft holder 511 forms a protrusion (not shown) for point-contacting the slope 531 of the lever 517.

The lens holder 509 includes a plate-shaped yoke 503 for circulating the magnetic flux of the magnets 507. The magnets 507 and the coils 515 of the lens holder 509 are protected from the outside by a cover 501. The cover 515 forms a light passing hole 519 for passing a light to the lens group 103, and the cover 515 is coupled to the base 101. The cover 501 includes a second throughhole 521 for supporting the guide shaft 537 at the upper stage.

The lens holder 509 forms a coupling hole for fixing the magnets 507, and a first throughhole 541 for passing through the compression spring 505. The base 101 is coupled with a fixing block 513, which is coupled with hollow pipe pins 539 for passing through a lead wire connected to the coils 515.

The control unit 141 is embedded in the main body of the communication device. The control unit 141 is connected to the image sensor 111 and the coils 515 by using the wires or the flexible PCB. The keypad of the communication device includes a photo button for actuating the image sensor 111.

In the camera device according to the present embodiment, when the photo button is operated, the control unit 141 applies power to the coils 515. The control unit 141 actuates the lens holder 509 in order to make the image of the object to be clear, thereby performing a focusing.

The operation of the camera device according to the present embodiment will be described below.

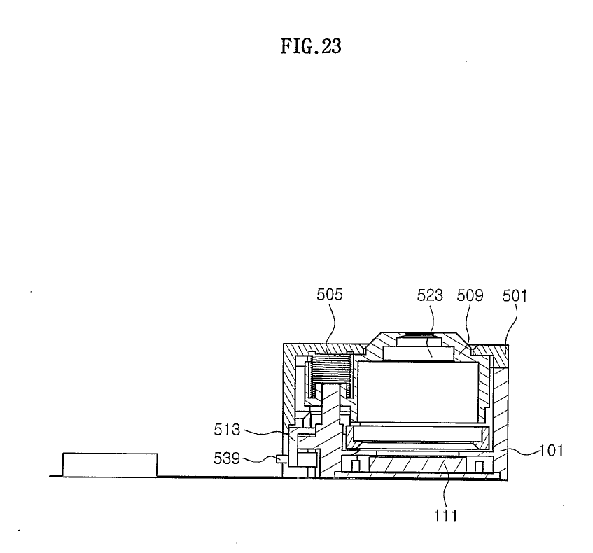

FIG. 22 is a cross-sectional view showing the state before operation of the camera device of the present embodiment. FIG. 23 is a cross-sectional view showing the state after operation of the camera device of the present embodiment.

The lever 517 is rotated to set the lens holder 509 at an appropriate height. The lever 517 rotates the slope 531 to adjust the height of the lens holder 509. If the height of the lens holder 509 is appropriately set, the lever 517 is coated with an adhesive to be fixed at the base 101.

After the lead wire passes through the pipe pins 539, the lead wire coats the pipe pins 539 and the fixing block 513 with an adhesive to prevent any movement. The spring 505 pressurizes the lens holder 509 by a predetermined elastic force. The lower surface of the lens holder 509 contacts the upper surface of the fixing block 513 to set its initial state.

The communication device includes a photo button. The control unit 141 firstly actuates the image sensor 111 to pick up the image of the object. The control unit 141 applies power to the coils 515 to actuate the lens holder 509. The control unit 141 performs a focusing to make the image of the object picked up by the image sensor 111 to be clear.

When the control unit 141 applies power to the coils 515, the coils 515 generate the magnetic field in the optical axis direction, and the repulsive force of the magnetic field generated in the optical axis direction raises the lens holder 509 in the optical axis direction. Due to the driving force, the lens holder 509 overcomes the elastic force of the spring 505 to rise. Accordingly, the lens holder 509 becomes able to freely oscillate. The control unit 141 finely adjusts the direction of the electric current applied to the coils 515.

The lens holder 509 is finely raised or lowered in the optical axis direction. The image sensor 111 makes the image of the object to be clear. The image of the object in front of the lens group 103 is converted into electric signals by the image sensor 111. The electric signals are transmitted to the control unit 141 through the flexible PCB.

The guide shaft 537 is coupled to the guide hole 527 of -the shaft holder 511 formed at the lens holder 509. The guide hole 527 guides the lens holder 509 to be driven in the optical axis direction.

### Embodiment 6

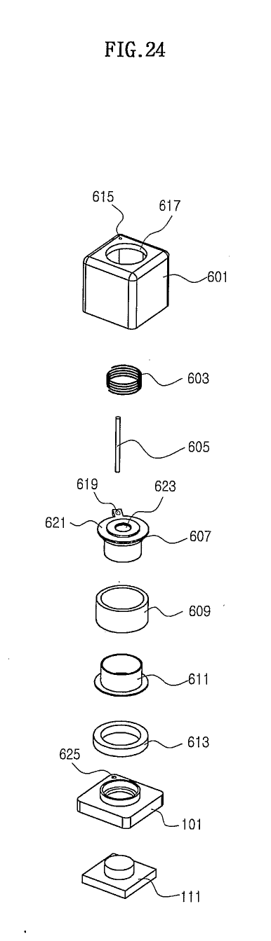

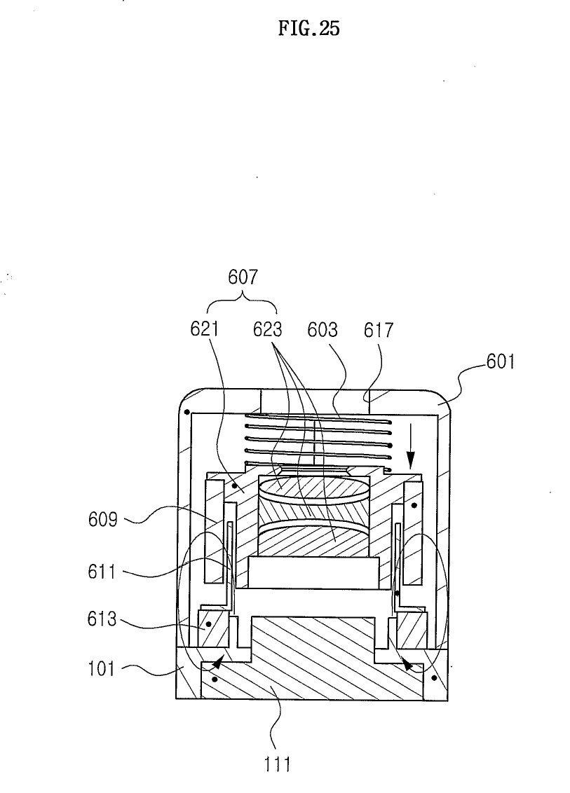

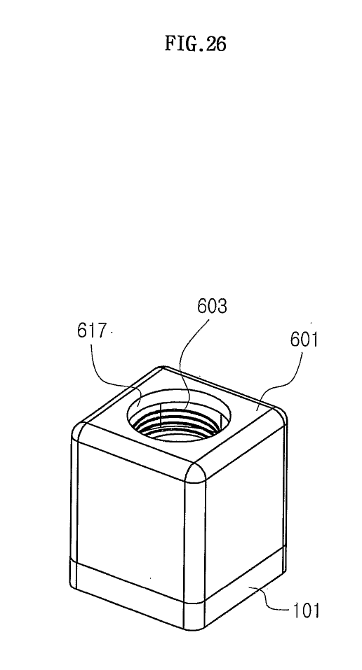

FIG. 24 is an exploded perspective view of the camera device according to the sixth embodiment of the present invention. FIG. 25 is a cross sectional view of FIG. 24 assembled together. FIG. 26 is a perspective view of FIG. 24 assembled together.

The camera device according to the sixth embodiment of the present invention comprises a base 101; an image sensor 111 fixed at the base 101; a lens group 103 consisting of a plurality of lenses for converting an image of an object, which is installed so that the image sensor 111 and the optical axis may travel in the optical axis direction as being in alignment with each other; a driving section 105 comprising a coil 609 which is wound at any one side of either the base 101 or the lens group 103 to be fixed, a magnet 613 fixed at the other side of either the base 101 or the lens group 103, and a yoke 611 which induces the magnetic flux of the magnet 613 to the coil 609 to generate the electromagnetic force in order to actuate the lens group 103 in the optical axis direction when power is applied to the coil 609; and a control unit 141 for applying power to the coil 609 to perform a zoom mode or a focusing mode responsive to the image signal detected at the image sensor 111.

The lens group 103 includes a plurality of lenses for converting an image of an object to a certain magnification, and a housing 621 for fixing the lenses 623. The coil 609 is wound in a cylindrical shape to be adhered to the outer periphery of the housing 621. The yoke 611 is made in a cylindrical shape to be installed in the coil 609.

The magnet 613 is of a circular shape, and is magnetized so as to have N polarity upward. The magnetic flux from the magnet 613 passes through the coil 609 via the yoke 611, and then returns to S polarity of the magnet 613. Accordingly, the coil 609 is raised or lowered according to the direction of the input electric current.

The control unit 141 applies a weak electric current to the coil 609 to move the lens group 103 at a fine width. The lens group 103 makes the focus of the image picked up by the image sensor 111 to be clear.

The base 101 comprises a cover 601 for protecting the lens group 103, the coil 609, and the magnet 613. The upper portion of the cover 601 includes an opening 617 for passing a light to each lens of the lens group 103.

The movable lens group 623 has a guide means so as to move in the optical axis direction. The guide means is fixed at the base 101 in the optical axis direction, and consists of a guide hole 619 formed at the housing 621 of the lens group 103 and a guide shaft 605 coupled to the guide hole 619 so as to be slidable in the optical axis direction. The lower portion of the guide shaft 605 is coupled to a first coupling hole 625. The upper portion of the guide shaft 605 is coupled to a second coupling hole 615.

The lens group 103 has restoring means for restoring the lens group 103 to its initial position. The restoring means includes a compression spring 603 which is supported by the cover 601 which covers the surrounding of the lens groups 103 and exerts an elastic force to the lens group 103.

The control unit 141 is embedded in the main body of the communication device. The control unit 141 is connected to the image sensor 111 and the coil 609 by using a wire or a flexible PCB. A keypad of the communication device includes a photo button for actuating the image sensor 111.

According to the camera device of the present invention, when the photo button for operating the image sensor 111 is operated, the control unit 141 applies power to the coil 609 to actuate the lens group 103. The control unit 141 performs a focusing to make an image of an object picked up by the image sensor 111 to be clear.

The operation of the camera device according to the sixth embodiment will be described below.

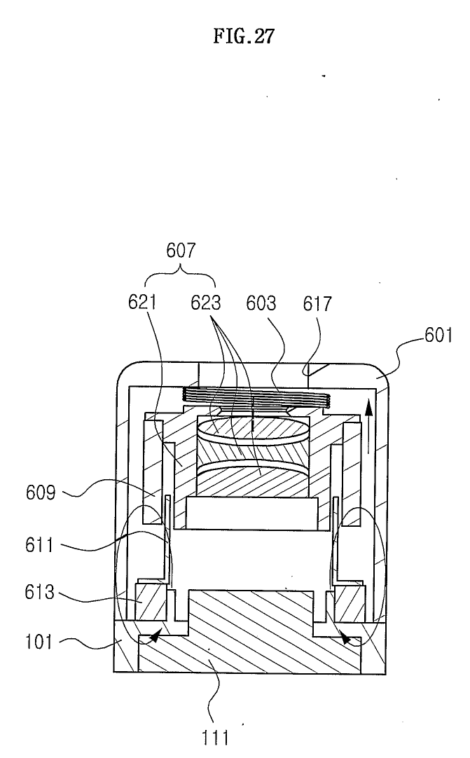

FIG. 25 is a cross-sectional view showing the state before operation of the camera device according to the sixth embodiment of the present invention. FIG. 27 is a cross-sectional view showing the state of operation after the camera device according to the sixth embodiment of the present invention.

The lens group 103 is fixed at the initial position as shown in FIG. 25. The compression spring 603 pushes the lens group 103 toward the image sensor 111 to remain in the stable initial position. When the photo button is operated, the control unit 141 applies power to the coil 609 to actuate the lens group 103. The lens module 607 performs a focusing to clarify the image of the object.

When the control unit 141 applies power to the coil 609, an electromagnetic force is generated by an electric field occurring at the coil 609 and by a magnetic flux which is generated at the magnet 613 and has moved to the yoke 611. The electromagnetic force raises the coil 609. The lens group 103 overcomes the elastic force of the compression spring 603 to rise. The lens group 103 becomes able to freely oscillate.

The control unit 141 finely adjusts the direction of the electric current applied to the coil 609. The lens group 103 is finely raised or lowered to correct a focusing error of an image picked up by the image sensor 111.

The image of the object picked up by the lens group 111 is converted into electric signals by the image sensor 111. The electric signals are transmitted to the control unit 141 through the flexible PCB.

### Embodiment 7

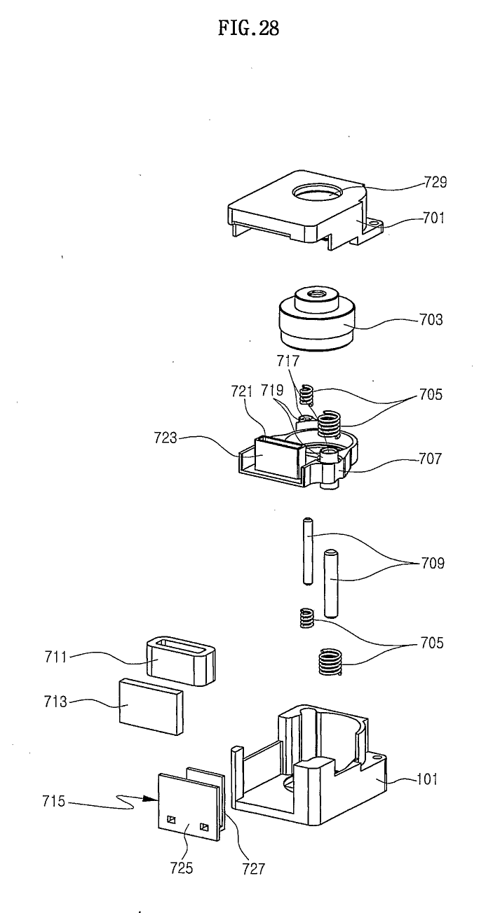

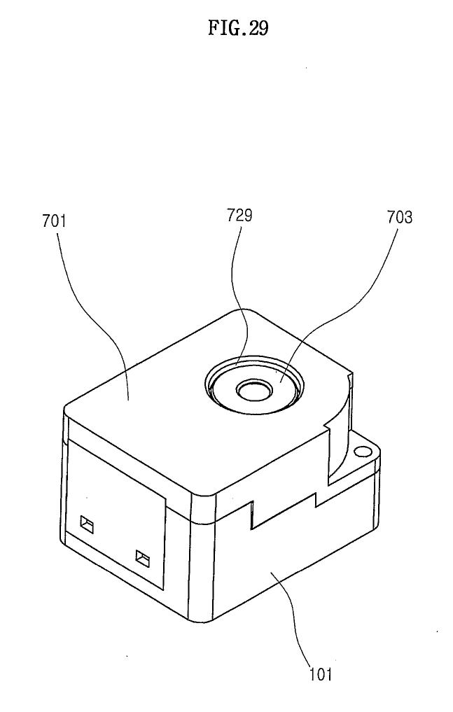

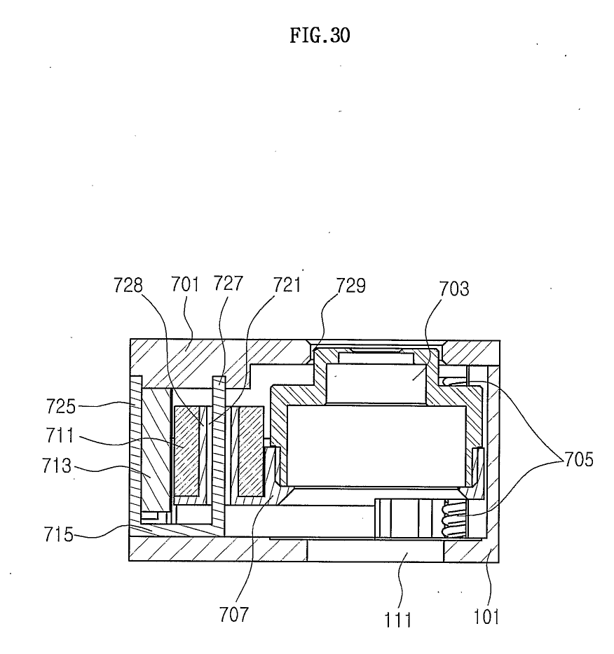

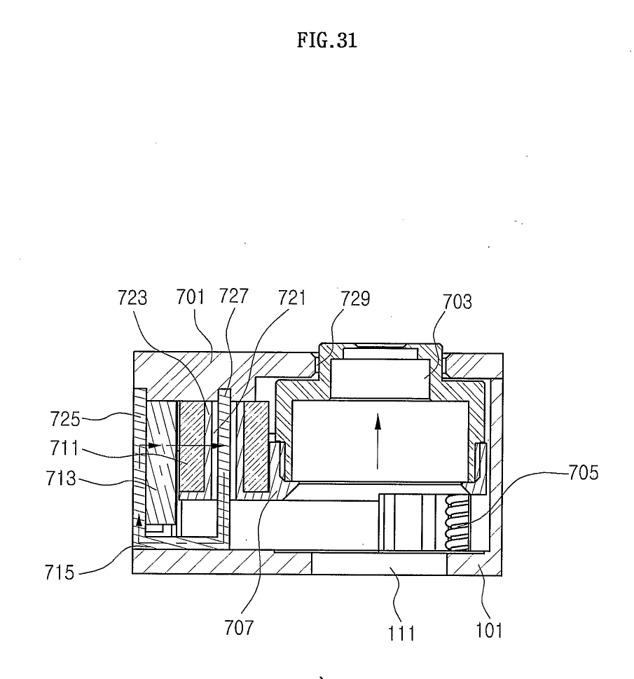

FIG. 28 is an exploded perspective view of the camera device according to the seventh embodiment of the present invention. FIG. 29 is a perspective view of FIG. 28 assembled together. FIGS. 30 and 31 are a longitudinal sectional view of FIG. 28 assembled together. The camera device of the present invention comprises a base 101; an image sensor 111 for picking up an image of an object, which is fixed at the base 101; a lens group 103 for converting the image of the object into a certain magnification, the lens group consisting of a plurality of lenses; a driving section 105 comprising a lens holder 707 for fixing the lens group 103; suspension means for supporting the lens holder 707 so as to travel on the base 101 in the optical axis direction; a gap regulator for actuating the lens holder 707 on the base 101 in the optical axis direction; and a control unit 141 for applying power to the driving section 105 to perform a zoom mode or a focusing mode responsive to image signals detected at the image sensor 111.

The suspension means includes at least two elastic members 705. The at least two elastic members 705 are supported by the base 101 to apply an elastic force to the lens holder 707 at both directions of the optical axis. The elastic members 705 are comprised of compression springs.

The gap regulator includes a coil 711 which is fixed at one side of either the base 101 or the lens holder 707, is wound in the orthogonal direction of the optical axis, and is applied power from the control unit 141; and a magnet 713 for providing the coil 711 with a magnetic flux in the orthogonal direction of the optical axis, the magnet being fixed at the other side of either the base 101 or the lens holder 707.

The gap regulator includes a yoke 715 of a magnetic substance for restoring the magnetic flux passed through the coil 711 to the magnet 713. The yoke 715 includes a supporting portion 725 for supporting the magnet 713; and an inserting portion 727 which forms a one-piece unit with the supporting portion 727 and is installed through the center of the coil 711.

The lens holder 707 has a bobbin 723 in which a cavity is formed. The coil 711 is wound around the bobbin 723, and the inserting portion 727 penetrates the cavity 721.

The control unit 141 detects a focusing error of the lens group 103 from the output signal transferred from the image sensor 111. The control unit 141 applies power to the coil 711 of the gap regulator to actuate the lens holder 707. Accordingly, the lens holder performs a focusing mode, so that the image of the object picked up by the image sensor 111 becomes clear.

The compact camera device of the present embodiment further comprises guide means for guiding the lens holder so as to move in the optical axis direction. The guide means includes at least one guide shaft fixed at the base 101 in the optical axis direction; and a shaft holder 719 having shaft holes 717 coupled to the guide shaft 709 so as to be slidable in the optical axis direction, the shaft holder being formed at the base 101. The elastic members 705 for supporting the lens holder 70 are inserted into the shaft holder to guide it.

In addition, the compact camera device of the present embodiment includes a cover 701 having a light passing hole 729 which passes a light to the lens group 103. The cover 701 is coupled to the base 101 to protect the lens group 103, the lens holder 707, and the gap regulator 713 from the outside.

The cover 701 is fixed at the base 101 by a fastening means such as a bolt. Among the elastic members 705, the elastic member 705, which presses the lens holder from the top of the optical axis, supports the upper part of the elastic member 705 with the cover 701. The control unit 141 is embedded in the main body of the communication device. The control unit 141 is connected to the image sensor and the coil 711 through a wire or a flexible PCB. The keypad of the communication device includes a photo button for actuating the image sensor 111.

When the photo button is operated, the control unit 141 applies power to the coil 711 to actuate the lens holder 707. The lens holder 707 makes the image of the object picked up by the image sensor 111 to be clear by a focusing operation.

The camera device of the present embodiment actuates the lens holder by a repulsive magnetic force occurring between the coils 711. Accordingly, the camera device of the present invention does not perform focusing operation by using a complex gear device.

The camera device of the present invention allows the miniaturization, and can be applied to compact communication devices. If the camera device of the present invention is applied to a mobile phone, the camera device can be installed in the main body or a folder, or in a hinge barrel for rotating the folder from the main body.

The operation of the camera device according to the present invention will be described below.

FIG. 30 is a longitudinal sectional view showing the state before operation of the camera device according to the seventh embodiment of the present invention. FIG. 31 is a longitudinal sectional view showing the state after operation of the camera device according to the seventh embodiment of the present invention.

Normally, the elastic members 705 pressurize the lens holder 707 up and down the optical axis, respectively. The lens holder 707 rises so as to travel in the optical axis direction.

When the photo button is operated by the keypad installed at the communication device, the control unit 141 actuates the image sensor 111. The image of the object passes through the lens group 103 to be picked up by the image sensor 111. The image sensor 111 converts the picked-up image into electric signals. The electric signals are transmitted to the control unit 141 through the flexible PCB.

The control unit 141 analyzes the image signals transmitted from the image sensor 111. As a result of the analysis, if the control unit 141 determines that the image of the object is not clear, the control unit 141 determines that a focusing error occurred at the lens group 103. The control unit 141 applies power to the coil 711 to actuate the lens holder 707.

When the control unit 141 applies power to the coil 711, the coil 711 generates an electromagnetic force in the optical axis direction by the magnetic flux of the orthogonal direction of the optical axis direction. Accordingly, the lens holder 707 is actuated in the optical axis direction.

The inserting portion 727 of the control unit 141 is inserted into the bobbin 723 disposed at the center of the coil 711. As indicated by the arrows in FIG. 31, the yoke 715 induces the magnetic flux passing through the coil 711, and moves it to the support 725. The magnetic flux, which moved to the support 725, returns to the magnet 713 again. As such, the yoke 715 forms a magnetic closed circuit. The magnetic flux from the magnet 713 is induced so as to effectively pass the coil 711.

Due to the driving force, the lens holder 707 overcomes the elastic force of the elastic members 705 to be actuated in the optical axis direction. The control unit 141 converts the electric current direction to raise or lower the lens holder 707 on the optical axis. Accordingly, the image of the object picked up by the image sensor becomes clear.

The guide shaft 709 is inserted into the shaft hole 717 of the shaft holder 719 formed at the lens holder 707. The lens holder 707 is guided so as to be accurately driven in the optical axis direction.

### INDUSTRIAL APPLICABILITY

The camera device of the present invention moves the movable lens group by using magnets and coils. This method allows the miniaturization of the camera device of the present invention. The camera device of the present invention includes two driving sections, which divide the moving area of the movable lens group into two areas. The movable lens group moves at a large width at any one moving area to perform zooming. The movable lens group moves at a small width at any one moving area to perform focusing. Accordingly, the camera device of the present invention can provide a zoom mode and a focusing mode.

The camera device of the present invention is applied to compact communication devices to provide an excellent image quality.

What is claimed is:

1. A compact camera device for communication devices, comprises:
a base;
a lens group for converting an image of an object to a certain magnification;
an image sensor for picking up an image of an object projected from said lens group, said image sensor being fixed at the base;
a driving section for finely moving said lens group in an optical axis direction; and
a control unit for outputting electrical control signals to said driving section to vary the image magnification of the object, said control unit driving said image sensor.

2. The compact camera device for communication devices according to claim 1, wherein said lens group comprises:
a fixed lens group which is fixed at said base and which is aligned with said image sensor in the optical axis direction; and
a movable lens group which changes its position in the optical axis direction by said driving section to vary a magnification.

3. The compact camera device for communication devices according to claim 1, wherein said driving section comprises:
a magnet which is fixed at any one side of either said base or said movable lens group and of which polarity is divided in the optical axis; and
a coil for generating a magnetic field toward said magnet responsive to said electrical signals, said coil being fixed at the other side of either said base or said movable lens group.

4. The compact camera device for communication devices according to claim 3, wherein said coil is provided with a yoke for concentrating the magnetic flux to said magnet and circulating the magnetic flux.

5. The compact camera device for communication devices according to claim 3, wherein said magnet is fixed at said movable lens group; said coil is made of a pair of coils; and said pair of coils are respectively installed at both ends of a path where said magnet moves.

6. The compact camera device for communication devices according to claim 3, wherein said control unit applies a strong electric current to said coil to thereby move said movable lens group at a large width in order to perform an optical zoom.

7. The compact camera device for communication devices according to claim 3, wherein said control unit applies a weak electric current to said coil to thereby move said movable lens group at a slight width in order to make a focal point of an image to be picked up by said image sensor.

8. The compact camera device for communication devices according to claim 1 or 2, wherein said base comprises a guide shaft which is fixed at said base in the optical axis direction; and
said movable lens group is fixed at a first lens barrel which includes a guide hole for passing through said guide shaft.

9. The compact camera device for communication devices according to claim 1 or 2, wherein said base includes a restoring means for pressurizing said movable lens group to its photographing position.

10. The compact camera device for communication devices according to claim 9, wherein said restoring means is a compression spring, which comprises the first lens barrel for fixing said movable lens group, said compression spring exerting an elastic force to said first lens barrel.

11. The compact camera device for communication devices according to claim 1, wherein said lens group comprises:
a fixed lens group fixed at said base which is aligned with said image sensor in the optical axis direction; and
a movable lens group installed so as to finely move in the optical axis direction,
wherein said driving section comprises:
a first driving section for actuating said movable lens group from a common photographing position to a 1-time zoom magnification photographing position; and
a second driving section for actuating said movable lens group from the 1-time zoom magnification photographing position to a 2-times zoom magnification photographing position, and
wherein said control unit controls said first driving section and said second driving section to vary respective image magnification.

12. The compact camera device for communication devices according to claim 11, wherein said first driving section comprises:
a first coil which is wound at any one side of either said base or said movable lens group, and is supplied with a electric current from said control unit; and
a first magnet for providing a magnetic flux of different directions to said first coil, said first magnet being installed at the other side of either said base or said movable lens group.

13. The compact camera device for communication devices according to claim 12, wherein said control unit applies a strong electric current to said first coil to move said movable lens group at a large width in order to perform an optical zoom.

14. The compact camera device for communication devices according to claim 12, wherein said control unit applies a weak electric current to said first coil to move said movable lens group at a small width in order to perform focusing operation.

15. The compact camera device for communication devices according to claim 11, wherein said second driving section comprises:
a second coil which is wound at any one side of either said base or said movable lens group, and is supplied with an electric current from said control unit; and
a second magnet for providing a magnetic flux of different directions to said second coil, said second magnet being fixed at the other side of either said base or said movable lens group.

16. The compact camera device for communication devices according to claim 15, wherein said control unit applies a strong electric current to said second coil to move said movable lens group at a large width in order to perform an optical zoom.

17. The compact camera device for communication devices according to claim 15, wherein said control unit applies a weak electric current to said second coil to move said movable lens group at a small width in order to perform focusing operation.

18. The compact camera device for communication devices according to claim 11, wherein said compact camera device further comprises guide means for guiding said movable lens group so as to move in the optical axis direction.

19. The compact camera device for communication devices according to claim 18, wherein said guide means comprises:
a guide shaft which is fixed at said base in the optical axis direction; and
a lens barrel having a guide hole through which said guide shaft passes, said lens barrel installing said movable lens group.

20. The compact camera device for communication devices according to claim 1, wherein said driving section comprises:
a lens holder for fixing said lens group so that said image sensor can be aligned with the optical axis;
a coil which is wound at said lens holder to be fixed;
a plate spring, one end of which is fixed at said base and the other end of which is connected to said coil to restore said coil to its initial position; and
a magnet fixed at said base which applies a magnetic flux to said coil to generate an electromagnetic force to actuate said lens holder in the optical axis direction,
characterized in that said control unit applies electrical signals to said coil through said plate spring.

21. The compact camera device for communication devices according to claim 20, wherein said compact camera device further comprises initial position setting means installed to said base for setting an appropriate initial position of said lens holder.

22. The compact camera device for communication devices according to claim 1, wherein said driving section comprises:
a lens holder for fixing said lens group so that said image sensor can be aligned with the optical axis;
a coil which is wound at said lens holder to be fixed;
a magnet fixed at said base, which applies a magnetic flux to said coil to generate an electromagnetic force which actuates said lens holder in the optical axis direction when power is applied to said coil; and
initial position setting means installed to said base for setting an appropriate initial position of said lens holder,
characterized in that said control unit applies electric signals to said coil.

23. The compact camera device for communication devices according to claim 21 or 22, wherein said initial position setting means comprises:
a second guide shaft fixed at said base in the optical axis direction;
a lever wherein a second shaft hole is formed so as to rotate on said second guide shaft and wherein a slope is formed at the upper part; and
a lifting prominence which is formed at the lens holder, and which contacts the slope to be raised and lowered by said lever.

24. The compact camera device for communication devices according to claims 20 to 22, wherein said compact camera device further comprises guide means for guiding said lens holder so as to move in the optical axis direction.

25. The compact camera device for communication devices according to claim 24, wherein said guide means comprises:
a first guide shaft fixed at said base in the optical axis direction; and
a shaft holder which is formed at said lens holder and which has a guide hole coupled to said guide shaft so as to be slidable in the optical axis direction.

26. The compact camera device for communication devices according to any one of claims 20 to 22, wherein said compact camera device comprises a magnetic circulation yoke for inducing a magnetic flux of said magnet to said coil.

27. The compact camera device for communication devices according to claim 1, wherein a cover, which protects said lens holder and said driving section from the outside and which has a light passing hole passing a light to said lens group, is coupled to said base.

28. The compact camera device for communication devices according to claims 20 to 22, wherein said lens group comprises a filter at the upper side of said image sensor to block the infrared rays.

29. The compact camera device for communication devices according to claim 1, wherein said driving section comprises:
a lens barrel for aligning each lens of said lens group in the optical axis direction;
a suspension member for raising said lens barrel from said base so that said lens barrel can finely move at a predetermined interval away from said image sensor; and
an adjustment section for adjusting the gap between said lens group and said image sensor to clarify the image which has passed through said lens group and then is picked up by said image sensor.

30. The compact camera device for communication devices according to claim 29, wherein said suspension member comprises at least two wires of which both ends are supported by said base and of which the center portion is fixed at the side of said lens barrel.

31. The compact camera device for communication devices according to claim 30, wherein said wires comprise a spring portion having a tensile elastic force at its center portion.

32. The compact camera device for communication devices according to claim 29, wherein said adjustment section comprises:
a coil which is wound at any one side of either said base or said lens barrel and to which an electric current is applied from said control unit; and
a magnet which is fixed at the other side of either said base or said lens barrel and of which polarity is divided so that a magnetic flux may pass any horizontal portion of said coil.

33. The compact camera device for communication devices according to claim 32, wherein said adjustment section further comprises a magnetic substance for effectively circulating the magnetic flux of said magnet, said magnetic substance being fixed at said base that is the backside of said magnet.

34. The compact camera device for communication devices according to claim 29, wherein said compact camera device further comprises a guide means so that said movable lens group can move in the optical axis direction.

35. The compact camera device for communication devices according to claim 34, wherein said guide means comprises a guide shaft which is fixed at said base in the optical axis direction and coupled to said guide hole formed at said lens barrel so as to be slidable.

36. The compact camera device for communication devices according to claim 1, wherein said driving section comprises:
a lens holder for fixing said lens group as said image sensor is aligned with the optical axis;
a coil for generating a magnetic field in the optical axis direction when an electric current is applied, said coil being wound at one side of either said base or said lens holder;
a magnet for actuating said lens holder by a repulsive force with the magnetic field of said coil, said magnet being fixed at the other side of either said base or said lens holder to which said coil is not fixed; and
an initial position setting means installed to said base for adjusting an initial position of said lens holder,
characterized in that said control unit applies power to said coil to adjust the focusing of said lens group.

37. The compact camera device for communication devices according to claim 36, wherein said initial position setting means comprises:
a lever which forms a slope for raising or lowering said lens holder in the optical axis direction, said lever being supported by said base so as to be rotatable; and
an elastic member for pushing said lens holder toward said lever.

38. The compact camera device for communication devices according to claim 36, wherein said compact camera device further comprises guide means for guiding said lens holder so as to move in the optical axis direction.

39. The compact camera device for communication devices according to claim 38, wherein said guide means comprises:
a first guide shaft fixed at said base in the optical axis direction; and
a shaft holder having a shaft hole which is coupled to said guide shaft so as to be slidable in the optical axis direction, said shaft holder being formed at said lens holder.

40. The compact camera device for communication devices according to claim 38, wherein said guide means comprises:
a guide protrusion formed at said lens holder; and
a guide groove for guiding said guide protrusion so as to be slidable in the optical axis direction, said guide groove being formed at said base in the optical axis direction.

41. The compact camera device for communication devices according to claim 36, wherein said compact camera device comprises a yoke for circulating the magnetic flux of said magnet.

42. The compact camera device for communication devices according to claim 36, wherein said compact camera device further comprises:
a fixing block coupled to said base; and
pipe pins which are coupled so as to pass through said fixing block and which have a cavity through which a lead wire connected to said coil passes.

43. The compact camera device for communication devices according to claim 1, wherein said lens group consists of a plurality of lenses which convert an image of an object to a certain magnification and which is installed so as to finely move in the optical axis direction as said image sensor is aligned with the optical axis; and
wherein said driving section comprises a coil which is wound at one side of either said base or said lens group; a magnet fixed at the other side of either said base or said lens group; and a yoke induces the magnetic flux of said magnet to generate an electromagnetic force which actuates said lens module in the optical axis direction when power is applied to said coil,
characterized in that said control unit applies electric signals to said coil.

44. The compact camera device for communication devices according to claim 43, wherein said control unit applies a weak electric current to said coil to move said lens group at a small width to thereby clarify the focus of the image of the object which is passed through each lens of said lens group and is picked up by said image sensor.

45. The compact camera device for communication devices according to claim 43, wherein said compact camera device further comprises guide means for guiding said movable lens group so as to move in the optical axis direction.

46. The compact camera device for communication devices according to claim 45, wherein said guide means consists of a guide shaft which is fixed at said base in the optical axis direction and which is coupled to said guide hole formed at said lens group so as to be slidable in the optical axis direction.

47. The compact camera device for communication devices according to claim 43, wherein said compact camera device comprises restoring means for restoring said lens module to its initial position.

48. The compact camera device for communication devices according to claim 47, wherein said restoring means comprises a compression spring which is supported by a cover surrounding said lens module to exert an elastic force to said lens module.

49. The compact camera device for communication devices according to claim 1, wherein said compact camera device further comprises:
a lens holder for fixing said lens group; and
a suspension member for supporting said lens holder so as to finely move on said base in the optical axis direction,
characterized in that said driving section actuates said lens holder on said base in the optical axis direction.

50. The compact camera device for communication device according to claim 1, wherein said suspension means comprises at least two elastic members for maintaining the balance of said lens holder by exerting an elastic force at both sides of the optical axis, said suspension means being supported on said base.

51. The compact camera device for communication device according to claim 49, wherein said driving section comprises:
a coil which is fixed at any one side of either said base or said lens holder, which is wound in the orthogonal direction of the optical axis, and to which power is supplied from said control unit; and
a magnet which is fixed at the other side of either said base or said lens holder and which provides a magnetic flux in the orthogonal direction of the optical axis.

52. The compact camera device for communication device according to claim 51, wherein said driving section further comprises a yoke of a magnetic substance for restoring the magnetic flux, which has passed said coil, to said magnet.

53. The compact camera device for communication devices according to claim 52, wherein said yoke comprises:
a supporting portion for supporting said magnet; and
an inserting portion which is integrated with said supporting portion and which is installed through the center of said coil.

54. The compact camera device for communication devices according to claim 51, wherein said lens holder comprises a bobbin which is wound around said coil and which has a cavity so that said inserting portion can pass through the center thereof.

55. The compact camera device for communication devices according to claim 49, wherein said control unit detects a focusing error of said lens group from the output signals transmitted from said image sensor, and actuates said lens holder when a focusing error occurs, thereby making an image of an object to be clear.

56. The compact camera device for communication devices according to claim 49, wherein said compact camera device further comprises guide means for guiding said lens holder so as to move in the optical axis direction.

57. The compact camera device for communication devices according to claim 56, wherein said guide means comprises:
at least one guide shaft fixed at said base in the optical axis direction; and
a shaft holder which is formed at said lens holder and which has a shaft hole coupled to said guide shaft so as to be slidable in the optical axis direction.
